(19) United States
(12) Patent Application Publication
(10) Pub. No.: US 2024/0286126 A1
(43) Pub. Date: Aug. 29, 2024

(54) IN VITRO DIAGNOSTIC CHIP HAVING MULTIPLE LEVELS OF HYDROPHILICITY

(71) Applicant: OPTOLANE TECHNOLOGIES INC., Gyeonggi-do (KR)

(72) Inventors: Seung Sun CHO, Gyeonggi-do (KR); An Shik CHOI, Seoul (KR); Byoung Joo KWAK, Gyeonggi-do (KR); Sergiy OLEKSANDROV, Gyeonggi-do (KR); Jae Hun KIM, Seoul (KR)

(21) Appl. No.: 18/573,475

(22) PCT Filed: Jun. 10, 2022
(86) PCT No.: PCT/KR2022/008206

§ 371 Date: Dec. 22, 2023

(30) Foreign Application Priority Data
Jun. 23, 2021 (KR) 10-2021-0081935

(51) Int. Cl. B01L 3/00

(52) U.S. Cl. CPC B01L 3/502; B01L 2200/0684; B01L 2200/14; B01L 2300/042; B01L 2300/0829; B01L 2300/161; B01L 2400/088

(57) ABSTRACT

Disclosed is an in vitro diagnostic chip having multiple levels of hydrophilicity, which differentially controls the flow rates of a liquid sample and thus enables the liquid sample to be evenly distributed all the way to corner or edge regions of a reaction space. The in vitro diagnostic chip having multiple levels of hydrophilicity comprises: a well array comprising a plurality of wells; and a multi-hydrophilic coating layer coated on the well array and controlling the flow rates of a sample so as to be mutually different. The hydrophilic coating layer is formed on the well array so as to have high hydrophilicity in accordance with the center region of the well array, and to have low hydrophilicity in accordance with the peripheral region of the well array, and thus the formation of an air pocket in the reaction space may be blocked. Accordingly, the occurrence of an error caused by the air pocket in a PCR test result may be prevented.

### TECHNICAL FIELD

The present application claims the benefit of priority based on Korean Patent Application No. 10-2021-0081935 filed on Jun. 23, 2021, the entire disclosure of which is incorporated as a part of this specification.

The present disclosure relates to an in vitro diagnostic chip having multiple levels of hydrophility, and more particularly, to an in vitro diagnostic chip having multiple levels of hydrophility which may differentially control flow rates of a liquid sample to evenly distribute the liquid sample to corners or edge areas of a reaction space.

### BACKGROUND ART

Gene amplification technology is an essential process in molecular diagnosis, and is a technology that repeatedly copies and amplifies a specific base sequence of trace amounts of deoxyribonucleic acid (DNA) or ribonucleic acid (RNA) in a sample. In particular, polymerase chain reaction (PCR) is a representative gene amplification technology and consists of three steps, which are DNA denaturation step, primer binding (annealing) step, and DNA replication (extension) step, and since each step depends on the temperature of the sample, DNA may be amplified by repeatedly changing the temperature of the sample.

Previously, PCR was typically performed in 96 or 384-well micro well plates. When higher throughput is required, conventional PCR methods on micro well plates require extensive use of reagents and are therefore not cost effective or efficient. Meanwhile, reducing PCR reaction volume may reduce the consumption of reagents and reduce amplification time at the reduced thermal mass of the reaction volume. This strategy may also be implemented in an array format (m×n), resulting in implementing many smaller reaction volumes. In addition, use of either array allows for scalable high-throughput analysis with increased quantitative sensitivity, dynamic range and specificity.

Using very large numbers of arrays in very small reaction volumes, digital polymerase chain reaction (dPCR) may be performed. Results from dPCR maybe used to detect and quantify the concentration of rare alleles, provide absolute quantification of nucleic acid samples, and also measure fold changes at low nucleic acid concentrations.

The array format of most quantitative polymerase chain reaction (qPCR) platforms is designed for sample-by-sample analysis, where PCR results must be addressable for subsequent analysis. However, dPCR does not analyze the specific location of each PCR result, but only analyzes the number of positive and negative target copies per sample.

### DISCLOSURE OF THE INVENTION

### Technical Goals

Accordingly, a technical challenge of the present disclosure is focused on this point, and an object of the present disclosure is to provide an in vitro diagnostic chip having multiple levels of hydrophility which may differentially control flow rates of a liquid sample to evenly distribute the liquid sample to corners or edge areas of a reaction space.

### Technical Solutions

In order to realize the above object, an in vitro diagnostic chip having multiple levels of hydrophility according to an embodiment includes a well array including a plurality of wells; and a multi-hydrophilic coating layer coated on the well array to control flow rates of a sample differently.

### Advantageous Effects

According to the in vitro diagnostic chip having multiple levels of hydrophility, by forming a multi-hydrophilic coating layer having high hydrophilicity corresponding to a central region of the well array and having low hydrophilicity corresponding to a peripheral region of the well array, it is possible to prevent creation of air pockets in the reaction space. Accordingly, it is possible to prevent errors caused by air pockets in PCR test results.

### BRIEF DESCRIPTION OF DRAWINGS

FIG. 1 is a perspective view for explaining an in vitro diagnostic chip having multiple levels of hydrophility according to an embodiment of the present disclosure.

FIG. 2 is a perspective view of the in vitro diagnostic chip having multiple levels of hydrophility shown in FIG. 1 with a guide member and a well cover removed.

FIG. 3 is an exploded perspective view for explaining the in vitro diagnostic chip having multiple levels of hydrophility shown in FIG. 1.

FIG. 4 is a cross-sectional view for explaining a coupling relationship of the in vitro diagnostic chip having multiple levels of hydrophility shown in FIG. 3.

FIG. 5 is an exploded perspective view for explaining multiple films of the in vitro diagnostic chip having multiple levels of hydrophility shown in FIG. 3.

FIG. 6 is an exploded perspective view for explaining a chip housing and an inserting member shown in FIG. 3.

FIG. 7 is a perspective view for schematically explaining an input of a sample and a release of air into the in vitro diagnostic chip having multiple levels of hydrophility shown in FIG. 3.

FIG. 8 is a diagram for sequentially explaining an introduction of a sample by a multi-hydrophilic coating layer coated on a well array shown in FIG. 3.

### BEST MODE FOR CARRYING OUT THE INVENTION

In order to realize the above object, an in vitro diagnostic chip having multiple levels of hydrophility according to an embodiment includes a well array including a plurality of wells; and a multi-hydrophilic coating layer coated on the well array to control flow rates of a sample differently.

In an embodiment, the multi-hydrophilic coating layer may have high hydrophilicity corresponding to a central region of the well array and have low hydrophilicity corresponding to a peripheral region of the well array.

In an embodiment, the in vitro diagnostic chip having multiple levels of hydrophility may further include a chip housing; and an inserting member which is inserted and accommodated in the chip housing and configured to accommodate the well array.

In an embodiment, the inserting member may include silicone.

In an embodiment, the chip housing may include a side portion in which one or more pinching holes or pinching grooves are formed, and the inserting member may include a side portion on which one or more pinching protrusions to be inserted into the pinching holes are formed.

In an embodiment, the inserting member may be coupled to an upper surface of the chip housing through a bottom surface, and a receiving groove may be formed to accommodate the well array in an upper surface of the inserting member.

In an embodiment, in the upper surface of the inserting member, a sample injection port through which the sample is injected, a sample injection part having a width decreasing from the sample injection port to the well array, and an air vent connecting an outer surface of the well array and a maximum extension part of the sample injection part may be formed.

In an embodiment, a chip injection port may be formed in the chip housing corresponding to the sample injection port, and the sample injection port and the chip injection port may communicate with each other.

In an embodiment, the in vitro diagnostic chip having multiple levels of hydrophility may further include a guide cap formed with a stopper protrusion which is inserted into the sample injection port through the chip injection port.

In an embodiment, the air vent may include a first air passage connecting one side of the well array and one side of the sample injection part, and a second air passage connecting the other side of the well array and the other side of the sample injection part.

In an embodiment, the in vitro diagnostic chip having multiple levels of hydrophility may further include an EEPROM accommodated in the chip housing and configured to store data for chip history management.

In an embodiment, the in vitro diagnostic chip having multiple levels of hydrophility may further include films configured to cover the well array, wherein the films includes an emission film.

In an embodiment, the in vitro diagnostic chip having multiple levels of hydrophility may further include a well cover configured to cover the well array; and a guide member configured expose a portion of the well cover through a hollow hole formed by covering the well cover.

### MODES FOR CARRYING OUT THE INVENTION

Hereinafter, the present disclosure will be described in more detail with reference to the attached drawings. Since the present disclosure may be variously modified and may have various forms, specific embodiments will be illustrated in the drawings and described in detail in the detailed description. However, this is not intended to limit the present disclosure to a specific disclosed form, and it should be understood that all modifications, equivalents, and substitutes are included in the spirit and scope of the present disclosure.

In describing each drawing, similar reference numerals are used for similar components. In the attached drawings, the dimensions of structures are enlarged from the actual sizes for clarity of the present disclosure.

Terms such as first and second may be used to describe various components, but the components should not be limited by the terms. The terms are used only for the purpose of distinguishing one component from another. For example, a first component may be referred to as a second component without departing from the scope of the present disclosure, and similarly, the second component may also be referred to as a first component. Singular expressions include plural expressions unless the context clearly means otherwise.

In this specification, it should be understood that terms such as “include” or “have” are intended to designate the presence of features, numbers, steps, operations, components, parts, or combinations thereof described in the specification, but do not preclude the possibility of the presence or addition of one or more other features, numbers, steps, operations, components, parts, or combinations thereof.

In addition, unless otherwise defined, all terms used herein, including technical or scientific terms, have the same meaning as those generally understood by a person skilled in the art to which the present disclosure pertains. Terms defined in dictionaries generally used should be construed to have meanings matching contextual meanings in the related art and are not to be construed as an ideal or excessively formal meaning unless otherwise defined herein.

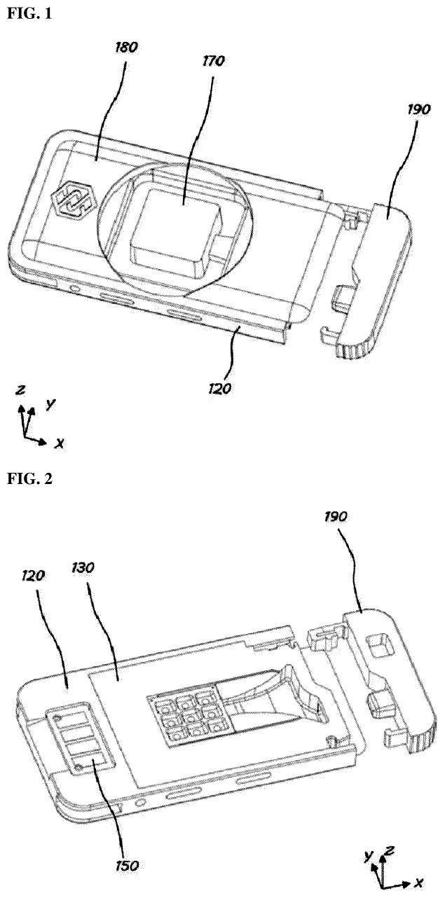

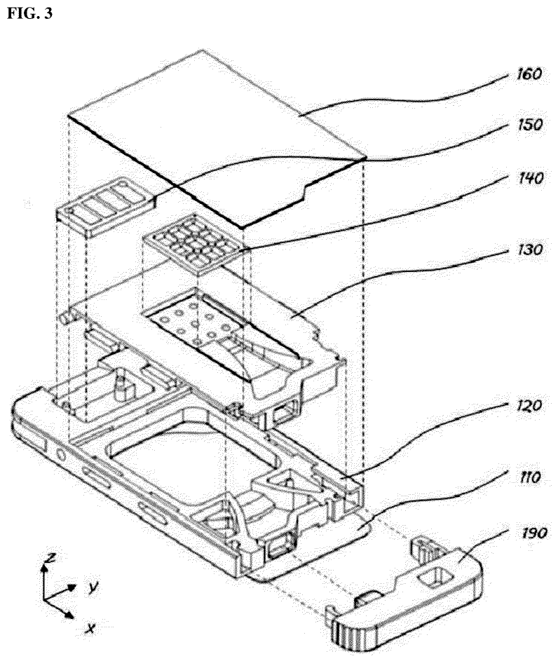

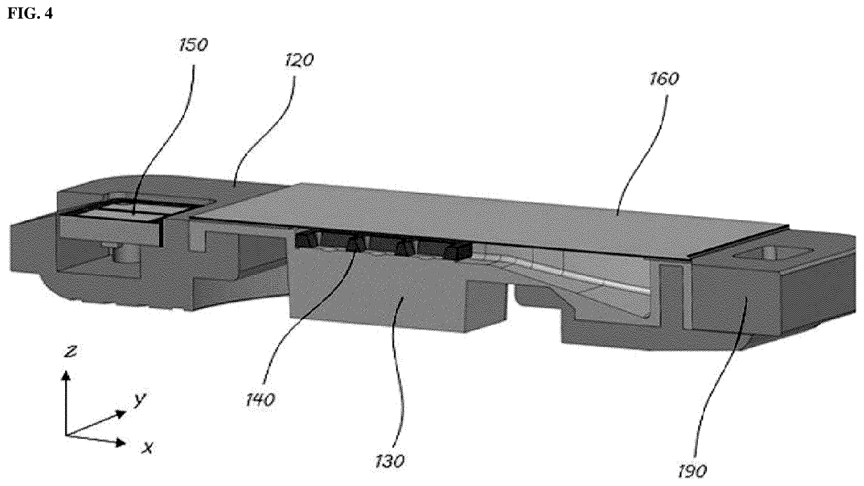

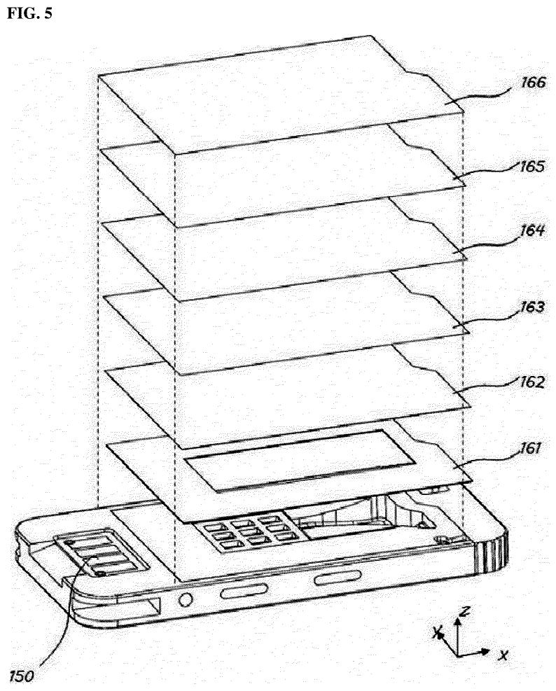

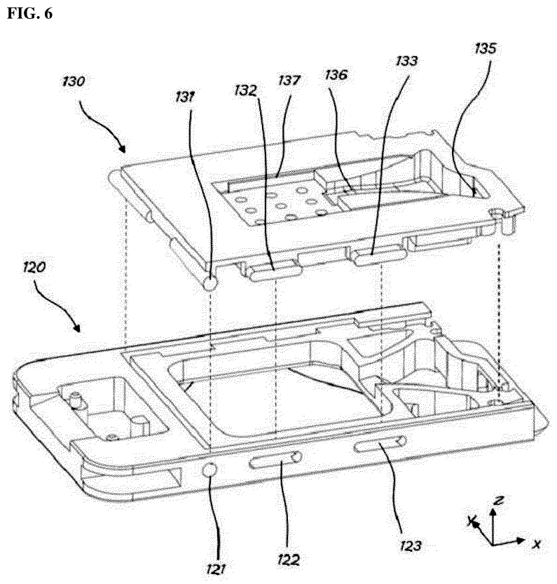

FIG. 1 is a perspective view for explaining an in vitro diagnostic chip having multiple levels of hydrophility according to an embodiment of the present disclosure. FIG. 2 is a perspective view of the in vitro diagnostic chip having multiple levels of hydrophility shown in FIG. 1 with a guide member and a well cover removed. FIG. 3 is an exploded perspective view for explaining the in vitro diagnostic chip having multiple levels of hydrophility shown in FIG. 1. FIG. 4 is a cross-sectional view for explaining a coupling relationship of the in vitro diagnostic chip having multiple levels of hydrophility shown in FIG. 3. FIG. 5 is an exploded perspective view for explaining multiple films of the in vitro diagnostic chip having multiple levels of hydrophility shown in FIG. 3.

Referring to FIGS. 1, 2, 3, 4, and 5, the in vitro diagnostic chip having multiple levels of hydrophility according to an embodiment of the present disclosure includes a base member 110, a chip housing 120, an inserting member 130, a well array 140, an EEPROM 150, films 160, a well cover 170, a chip cover 180, and a guide cap 190.

The base member 110 is disposed on a lower surface of the chip housing 120.

In an upper part of the chip housing 120, a hole for insertion of the inserting member 130 and a groove for insertion of the EEPROM 150 are formed. The hole for insertion of the inserting member 130 is covered by the base member 110. A chip injection port is formed in a side portion of the chip housing 120 corresponding to a sample injection port, and the sample injection port and the chip injection port communicate with each other.

The inserting member 130 is inserted into the hole formed in the upper part of the chip housing 120 and accommodates the well array 140 and the EEPROM 150. The inserting member 130 may include a silicone material. In an upper surface of the inserting member 130, the sample injection port through which a sample is injected, a sample injection part having a width decreasing from the sample injection port to the well array 140, and an air vent connecting an outer surface of the well array 140 and a maximum extension part of the sample injection part are formed.

The well array 140 includes a plurality of wells and is accommodated in the inserting member 130. In this embodiment, the number of wells is shown as 9, but is not limited thereto. The well array 140 has an overall rectangular shape.

The EEPROM 150 is accommodated in a groove formed in the inserting member 130 and stores data for chip history management. Through this EEPROM 150, it is possible to write patient information directly into a ROM while collecting samples so that the patient information does not change, thereby eliminating inconvenience of manually writing patient information or attaching barcode tape. In addition, by storing a security key in EEPROM, illegal copying and use of the in vitro diagnostic chip may be prevented, making chip history management easier.

The films 160 cover the inserting member 130 that accommodates the well array 140. The films 160 include a tape 161 disposed at the bottom, an elastic buffer layer 162, an OCA film 163, an emission film 164, a moisture-proof protective film 165, and a carrier 166 for protecting the moisture-proof protective film. In this embodiment, the emission film 164 blocks excitation light generated from a light source (not shown) and transmits emission light generated from the sample within a reaction space 240.

The emission film 164 may include a base medium, semi-cured photoresist, and pigment. As the base medium, a transparent synthetic resin, glass, metal oxide, or the like may be used. In this embodiment, the base medium may include epoxy resin, silicone resin, etc., which have biocompatible properties while not generating fluorescence or phosphorescence. The semi-cured photoresist is dispersed in the base medium and includes photoresist fixed in a solid state by thermal curing, drying, photo curing, or the like. For example, the semi-cured photoresist may include a negative photoresist. In another embodiment, the semi-cured photoresist may include a positive photoresist.

It is not intended to limit the scope of the present disclosure by theory, but in order to explain the present disclosure in detail, the reason why the emission film 164 of the present disclosure has unique excellent optical characteristics is explained as follows.

A general color filter fixes a pigment in a transparent medium and selectively transmits light by absorbing light of a certain wavelength and transmitting light of a different wavelength. Due to the characteristic that the photoresist changes its chemical properties and optical properties in response to light with a short wavelength such as ultraviolet light, blue light, and green light, when the semi-cured photoresist is used in the color filter, there is a problem that the optical properties are changed over time. Therefore, in the conventional color filter, a thermosetting material that is completely saturated with light with a short wavelength such as ultraviolet light, blue light, and green light, or does not change even when a light with a short wavelength is irradiated, may be used.

However, since the emission film 164 of the present disclosure is used in disposable experimental equipment rather than for long-term use, there is no need to maintain the same optical properties for a long time, and the optical properties only need to be temporarily maintained for a relatively short experimental time. Specifically, when the semi-cured photoresist is irradiated with light with a short wavelength, such as ultraviolet light, blue light, or green light, it temporarily functions as an optical filter with excellent characteristics because it absorbs the light with a short wavelength for a certain period of time, and it becomes saturated with light of short wavelength and loses most of its optical filter function over time, and accordingly, the semi-cured photoresist, which is against long-term stability, cannot be used in conventional color filters.

The present disclosure conversely utilizes the property of the semi-cured photoresist to absorb light with a short wavelength in the process of being saturated and stabilized by light with a short wavelength such as ultraviolet light, blue light, and green light to implemented an emission film 164 with excellent optical properties that may be used in disposable experimental devices. In other words, by blocking the excitation light primarily by the pigment and blocking the excitation light secondarily by the semi-cured photoresist, the present disclosure succeeded in manufacturing an emission film 164 with excellent properties regardless of the direction of incident light, which existing color filters or interference filters could not achieve.

The pigment is a material that absorbs light of a certain wavelength, and for example, yellow pigment, red pigment, blue pigment, green pigment, etc. may be used. In this embodiment, the pigment includes a yellow pigment. Yellow pigments may include inorganic dyes such as lead chromate, calcium yellow, yellow oxides, and complex inorganic color pigments, bismuth vanadate, or organic dyes such as arylamide, diarylide, benzimidazolone, disazo ondensation, organic metal complexes, isoindoline, quinophthalone, anthrapyrimidine, and flavanthrone.

The well cover 170 has a size that may cover the well array 140 and is disposed on the films 160 disposed on the inserting member 130 that accommodates the well array 140. The well cover 170 presses the films 160 by a user's pressing operation or the like, and thus pressurizes the well array 140 disposed below the films 160.

The chip cover 180 is fastened to the chip housing 120 so that the inserting member 130, well array 140, EEPROM 150, films 160, and well cover 170 are fixed. In a center portion of the chip cover 180, a circular hole is formed that exposes the well cover 170 for the pressing operation of the well cover 170 by the user.

In the guide cap 190, a stopper protrusion is formed that is inserted into the sample injection port through the chip injection port.

FIG. 6 is an exploded perspective view for explaining the chip housing and the inserting member shown in FIG. 3.

Referring to FIG. 6, the chip housing 120 has a rectangular shape. In a side portion of the chip housing 120, a first pinching hole 121, a second pinching hole 122, and a third pinching hole 123 are formed. In addition, although not shown, in a side portion of the chip housing 120, a fourth pinching hole, a fifth pinching hole, and a sixth pinching hole facing the first pinching hole 121, the second pinching hole 122, and the third pinching hole 123, respectively, are formed.

On a side portion of the inserting member 130, a first pinching protrusion 131 to be inserted into the first pinching hole 121 of the chip housing 120, a second pinching protrusion 132 to be inserted into the second pinching hole 122 of the chip housing 120, and a third pinching protrusion 133 to be inserted into the third pinching hole 123 of the chip housing 120 are formed. Although not shown, a fourth pinching protrusion, a fifth pinching protrusion, and a sixth pinching protrusion facing the first pinching protrusion 131, the second pinching protrusion 132, and the third pinching protrusion 133, respectively, are formed. The fourth pinching protrusion, fifth pinching protrusion, and sixth pinching protrusion formed on the inserting member 130 are inserted into the fourth pinching hole, fifth pinching hole, and sixth pinching hole formed in the chip housing, respectively.

In an upper surface of the inserting member 130, a sample injection port 135 through which a liquid sample is injected, a sample injection part 136 having a width decreasing from the sample injection port 135 to the well array 140, and an air vent 137 connecting an outer surface of the well array 140 and a maximum extension part of the sample injection part 136 are formed.

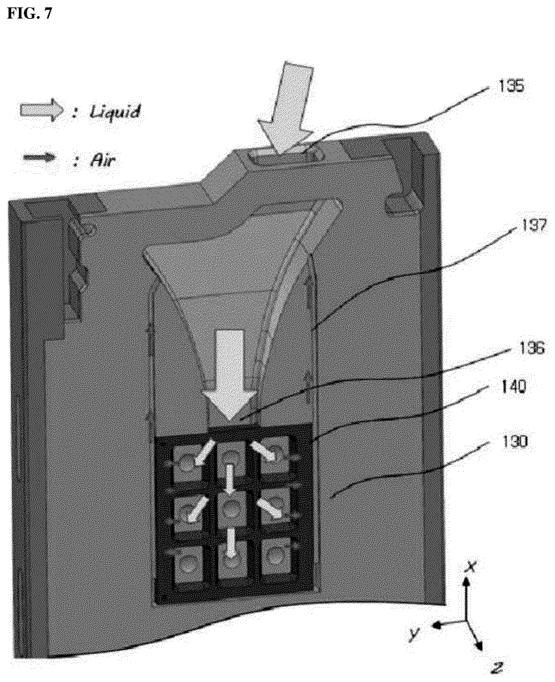

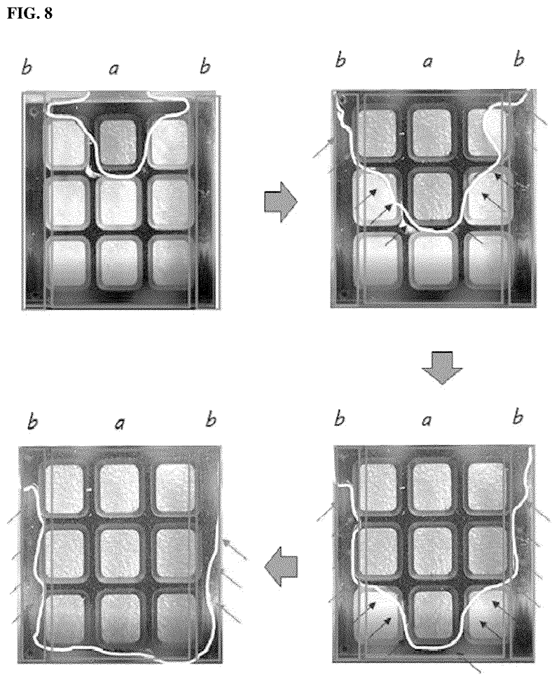

FIG. 7 is a perspective view for schematically explaining an input of a sample and a release of air into the in vitro diagnostic chip having multiple levels of hydrophility shown in FIG. 3. FIG. 8 is a diagram for sequentially explaining an introduction of a sample by a multi-hydrophilic coating layer coated on the well array shown in FIG. 3.

Referring to FIGS. 7 and 8, the liquid sample introduced into the sample injection port gradually spreads downward by gravity. A first hydrophilic coating layer HYD-H is coated in a central region of the well array, and a first peripheral region and a second peripheral region of the well array are coated with a second hydrophilic coating layer HYD-L having lower hydrophilicity than the first hydrophilic coating layer HYD-H. Therefore, the flow rate of the liquid sample flowing in the central region of the well array is faster than the flow rate of the liquid sample flowing in the first and second peripheral regions of the well array.

Specifically, the liquid sample injected into the sample injection port first reaches the center well of the top row. At this time, air existing in the center well of the top row is moved to the left and right wells of the top row and the wells below.

Subsequently, the liquid sample reaches the left and right wells of the top row and the center well of the middle row. At this time, the air existing in the left and right wells of the top row and the air existing in the center well of the top row are moved to the wells below.

Subsequently, the liquid sample reaches the left and right wells of the middle row and the center well of the bottom row. At this time, the air existing in the left and right wells of the middle row and the center well of the bottom row is moved to the wells below.

Subsequently, the liquid sample reaches the left and right wells of the bottom row. At this time, the air existing in the left and right wells of the bottom row is discharged to the outside through the air vent.

In this way, due to the difference in hydrophilicity of the well array, air is discharged until the end through the air vent, which is a passage through which air can escape, thereby preventing bubble traps.

As described above, according to the present disclosure, by forming a hydrophilic coating layer on the well array to have high hydrophilicity corresponding to the central region of the well array and low hydrophilicity to the peripheral region of the well array, it is possible to prevent air pockets from being created in the reaction space. Accordingly, it is possible to prevent errors caused by air pockets in PCR test results.

Although described above with reference to examples, those skilled in the art will understand that various modifications and changes may be made to the present disclosure without departing from the spirit and scope of the present disclosure as set forth in the appended claims.

<Explanation of Symbols>

| | |
|---|---|
| 110: Base member | 120: Chip housing |
| 130: Inserting member | 135: Sample injection port |
| 136: Sample injection part | 137: Air vent |
| 121, 122, 123: Pinching grooves | 131, 132, 133: Pinching protrusions |
| 140: Well array | 150: EEPROM |
| 160: Films | 170: Well cover |
| 180: Chip cover | 190: Guide cap |
| HYD-H: First hydrophilic coating | HYD-L: Second hydrophilic coating |
| layer | layer |

### INDUSTRIAL APPLICABILITY

The present disclosure has industrial applicability as a device for performing test of biochemical substances, a blood test device, a disease test device, and the like, which may be used for research, medical purposes, disaster prevention, livestock farming, and pet treatment.

1. An in vitro diagnostic chip having multiple levels of hydrophilicity, comprising:
a well array comprising a plurality of wells; and
a multi-hydrophilic coating layer coated on the well array to control flow rates of a sample differently.

2. The in vitro diagnostic chip of claim 1, wherein the multi-hydrophilic coating layer has high hydrophilicity corresponding to a central region of the well array and has low hydrophilicity corresponding to a peripheral region of the well array.

3. The in vitro diagnostic chip of claim 1, further comprising:
a chip housing; and
an inserting member which is inserted and accommodated in the chip housing and configured to accommodate the well array.

4. The in vitro diagnostic chip of claim 3, wherein the inserting member comprises silicone.

5. The in vitro diagnostic chip of claim 3, wherein the chip housing comprises a side portion in which one or more pinching holes or pinching grooves are formed, and
the inserting member comprises a side portion on which one or more pinching protrusions to be inserted into the pinching holes are formed.

6. The in vitro diagnostic chip of claim 3, wherein the inserting member is coupled to an upper surface of the chip housing through a bottom surface, and
a receiving groove is formed to accommodate the well array in an upper surface of the inserting member.

7. The in vitro diagnostic chip of claim 6, wherein, in the upper surface of the inserting member, a sample injection port through which the sample is injected, a sample injection part having a width decreasing from the sample injection port to the well array, and an air vent connecting an outer surface of the well array and a maximum extension part of the sample injection part are formed.

8. The in vitro diagnostic chip of claim 7, wherein a chip injection port is formed in the chip housing corresponding to the sample injection port, and the sample injection port and the chip injection port communicate with each other.

9. The in vitro diagnostic chip of claim 8, further comprising a guide cap formed with a stopper protrusion which is inserted into the sample injection port through the chip injection port.

10. The in vitro diagnostic chip of claim 7, wherein the air vent comprises a first air passage connecting one side of the well array and one side of the sample injection part, and a second air passage connecting the other side of the well array and the other side of the sample injection part.

11. The in vitro diagnostic chip of claim 2, further comprising an EEPROM accommodated in the chip housing and configured to store data for chip history management.

12. The in vitro diagnostic chip of claim 3, further comprising films configured to cover the well array,
wherein the films comprise an emission film.

13. The in vitro diagnostic chip of claim 3, further comprising:
a well cover configured to cover the well array; and
a guide member configured expose a portion of the well cover through a hollow hole formed by covering the well cover.
